(19) United States
(12) Patent Application Publication
(10) Pub. No.: US 2012/0105540 A1
(43) Pub. Date: May 3, 2012

(54) Liquid Ejecting Apparatus

(75) Inventors: Katsuyuki Kondo, Nagano-ken (JP); Seiji Kawabata, Nagano-ken (JP)

(73) Assignee: SEIKO EPSON CORPORATION, Tokyo (JP)

(21) Appl. No.: 13/280,997

(22) Filed: Oct. 25, 2011

(30) Foreign Application Priority Data
Oct. 28, 2010 (JP) 2010-241840

(51) Int. Cl. B41J 2/165

(52) U.S. Cl. 347/30

(57) ABSTRACT

In a printer, a transport mechanism and a waste ink container are arranged in this order from a recording paper accommodating section, the transport mechanism, a recording head, and an ink tank loading section are arranged in order of the recording head and the ink tank loading section from a side of the transport mechanism, the array direction of the recording paper accommodating section, the transport mechanism, and the waste ink container and the array direction of the transport mechanism, the recording head, and the ink tank loading section cross each other.

### CROSS-REFERENCE TO RELATED APPLICATION

Priority is claimed under 35 U.S.C. §119 to Japanese Application No. 2010-241840 filed on Oct. 28, 2010, which is hereby incorporated by reference in its entirety.

### BACKGROUND

1. Technical Field

The present invention relates to a liquid ejecting apparatus.

2. Related Art

Heretofore, a reduction in the size of an ink jet printer that is one type of a liquid ejecting apparatus has been desired. Then, various devices for attaining a reduction in size have been proposed. For example, in JP-A-2002-127551, JP-A-2003-127484, and JP-A-2006-205630, JP-A-2009-286115, so-called vertical installation type printers are disclosed in which by disposing a structure such as a recording head, an ink tank, or an electric circuit substrate, which is disposed in an ink jet printer, in the up-and-down direction as a whole, it is possible to attain a reduction in the installation area of the ink jet printer. In the case of making an ink jet printer a vertical installation type, it is possible to make an installation area small, compared to a so-called transverse installation type printer in which structures in an ink jet printer are disposed in the horizontal direction as a whole.

### SUMMARY

An advantage of some aspects of the invention is that it provides a liquid ejecting apparatus in which it is possible to attain a further reduction in size.

According to an aspect of the invention, there is provided a liquid ejecting apparatus including: a liquid ejecting head which ejects liquid; a suction mechanism which suctions the liquid from the liquid ejecting head; a target accommodating section which accommodates a target which becomes an ejection target of the liquid which is ejected from the liquid ejecting head; a transport mechanism which transports the target which is supplied from the target accommodating section, to a position where ejection of the liquid from the liquid ejecting head can be received; and a waste liquid container having a first container portion and a second container portion which store waste liquid discharged from the suction mechanism, wherein the target accommodating section, the transport mechanism, and the first container portion are arranged in order of the transport mechanism and the first container portion from a side of the target accommodating section.

By configuring the liquid ejecting apparatus in this manner, compared to a case where the first container portion is disposed in a direction which crosses a direction in which the target accommodating section and the transport mechanism are arranged, it is possible to make the size of the liquid ejecting apparatus with respect to the crossing direction small. That is, in a case where the crossing direction is the height direction of the liquid ejecting apparatus, it is possible to configure the liquid ejecting apparatus to have a low height. Further, in a case where the crossing direction is the depth direction of the liquid ejecting apparatus, it is possible to configure the liquid ejecting apparatus to have a small depth.

In addition to the above configuration, the liquid ejecting apparatus may further include a liquid container loading section which is disposed at a position different from the liquid ejecting head and into which a liquid container in which the liquid is stored is loaded, wherein the transport mechanism, the liquid ejecting head, and the liquid container loading section are arranged in order of the liquid ejecting head and the liquid container loading section from a side of the transport mechanism, a first direction which is the array direction of the target accommodating section, the transport mechanism, and the first container portion and a second direction which is the array direction of the transport mechanism, the liquid ejecting head, and the liquid container loading section cross each other, the liquid container loading section has a projecting portion which projects further than the liquid ejecting head and the transport mechanism in a direction which is a direction following the first direction and is a direction toward a side opposite to a side where the target accommodating section is disposed, and the first container portion is disposed in a space which is formed in a direction following the second direction and on the transport mechanism side of the projecting portion.

By configuring the liquid ejecting apparatus in this manner, it is possible to dispose the waste liquid container in the space, so that it is possible to provide the waste liquid container while suppressing an increase in the volume of the liquid ejecting apparatus.

In addition to the above configuration, in the liquid ejecting apparatus, the first direction may be a direction following the horizontal direction, the second direction may be the up-and-down direction, and the transport mechanism may be disposed at the lowest side in the array of the transport mechanism, the liquid ejecting head, and the liquid container loading section.

By configuring the liquid ejecting apparatus in this manner, the target accommodating section, the transport mechanism, and the waste liquid container are disposed at the lower side of the liquid ejecting apparatus, whereby it is possible to dispose the center of gravity of the liquid ejecting apparatus at a low position.

In addition to the above configuration, in the liquid ejecting apparatus, the second container portion may be provided to extend from the first container portion.

By configuring the liquid ejecting apparatus in this manner, the second container portion is provided at an end portion of the first container portion and disposed in a space which is formed below a driving portion of the transport mechanism and between the driving portion and a bottom portion of the liquid ejecting apparatus. In this manner, by providing the waste liquid container in the space, it is possible to effectively increase the capacity of the waste liquid container while suppressing an increase in the volume of the liquid ejecting apparatus.

In addition to the above configuration, in the liquid ejecting apparatus, a liquid absorber may be accommodated in the waste liquid container.

The liquid absorber can retain the absorbed liquid in the liquid absorber. For this reason, the liquid absorber is accommodated in the waste liquid container, whereby, even when the liquid ejecting apparatus has fallen, it is possible to prevent liquid from leaking immediately from the waste liquid container.

In addition to the above configuration, in the liquid ejecting apparatus, an inflow opening in which the waste liquid discharged from the liquid ejecting head by the suction mechanism flows into the waste liquid container may be disposed below a waste liquid discharging portion which is formed at a waste liquid receiving section which receives the waste liquid of the suction mechanism, and the liquid absorber may be accommodated in the waste liquid container such that a portion which is present toward the upper side from the inflow opening is present.

By configuring the liquid ejecting apparatus in this manner, it is possible to store the waste liquid at a position higher than the inflow opening, so that it is possible to attain an increase in the storage amount of the waste liquid which can be stored in the waste liquid container.

In addition to the above configuration, in the liquid ejecting apparatus, barriers which form a labyrinth pathway capable of hindering the movement of liquid discharged into the waste liquid container may be formed in the inside of the waste liquid container.

By configuring the liquid ejecting apparatus in this manner, even at the time of falling of the liquid ejecting apparatus, it is possible to make it difficult for the waste liquid to spill from the waste liquid container.

### BRIEF DESCRIPTION OF THE DRAWINGS

The invention will be described with reference to the accompanying drawings, wherein like numbers reference like elements.

FIG. 1 is a perspective view showing the appearance of a printer related to an embodiment of the invention.

FIG. 2 is a perspective view showing the appearance of the printer related to the embodiment of the invention.

FIG. 3 is a perspective view schematically showing the internal configuration of the printer shown in FIGS. 1 and 2.

FIG. 4 is a schematic configuration diagram of the internal configuration of the printer shown in FIGS. 1 and 2, viewed from the left side.

FIG. 5 is a fragmentary configuration diagram of a suction mechanism showing the configuration of a portion of the suction mechanism.

FIG. 6 is a perspective view showing the appearance of a waste ink container.

FIG. 7 is a perspective view showing the appearance of an ink absorber.

FIG. 8 is a perspective view showing a state where the ink absorber is accommodated in the waste ink container.

### DESCRIPTION OF EXEMPLARY EMBODIMENTS

### Overall Configuration of Printer 1

Hereinafter, the configuration of an ink jet printer (hereinafter simply referred to as a printer) 1 related to an embodiment of a liquid ejecting apparatus according to the invention will be described.

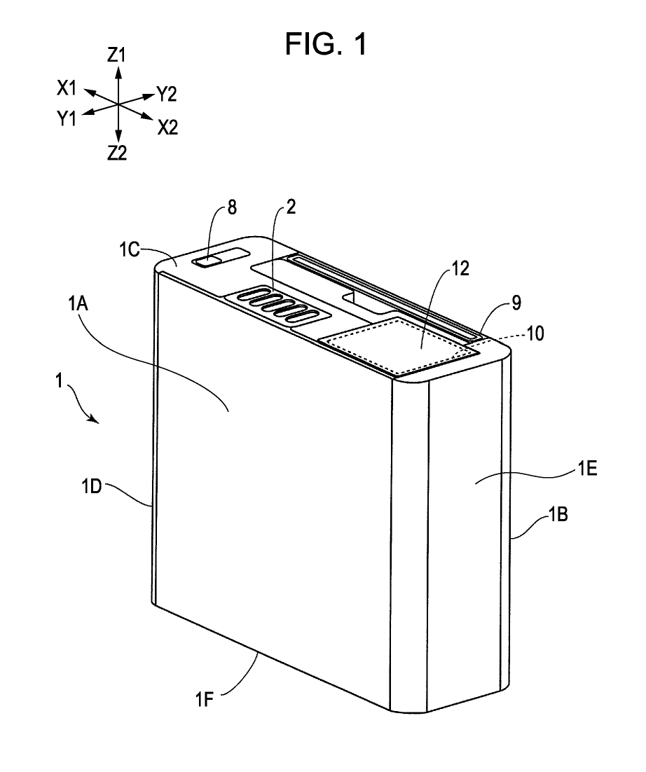

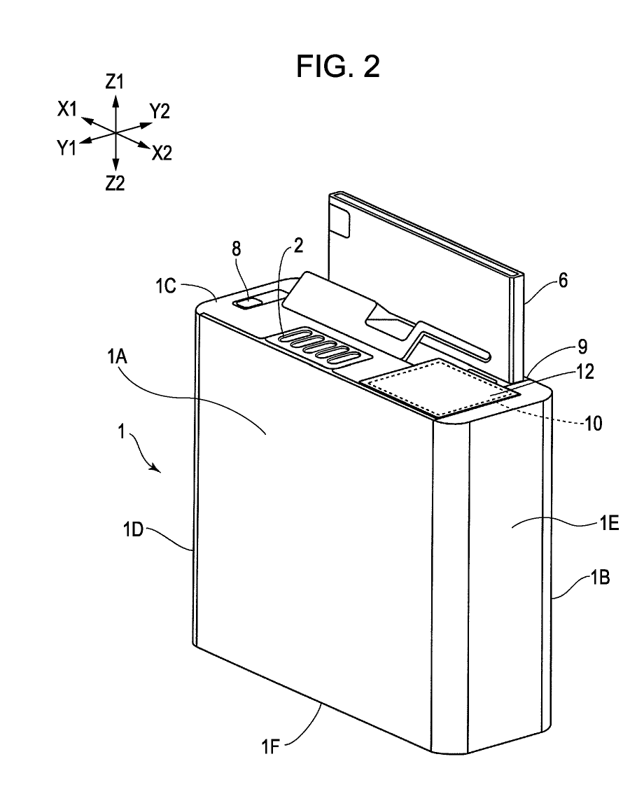

FIGS. 1 and 2 are perspective views showing the appearance of the printer 1. In the following explanation, a description will be performed with a direction of an arrow X1-X2 in the drawings set to be the left-and-right direction, a direction of an arrow Y1-Y2 in the drawings set to be the front-and-back direction, and a direction of an arrow Z1-Z2 in the drawings set to be the up-and-down direction.

A Z2 direction indicates a direction in which the installation surface of the printer 1 is located. That is, the Z2 direction becomes a downward direction. Further, a Y1 direction is a direction toward the front of the printer 1. The direction toward the front is a direction toward a standing position where an operator who operates the printer 1 easily performs an operation of the printer 1. That is, the printer 1 is configured such that in a case where the operator is located at the front of the printer 1 and operates the printer 1, various operations of the printer 1 such as operations of operation buttons 2 are easily performed. In addition, a left-hand direction toward a front surface 1A of the printer 1 is set to be the left side (a direction of an arrow X1 in the drawings) and a right-hand direction is set to be the right side (a direction of an arrow X2 in the drawings).

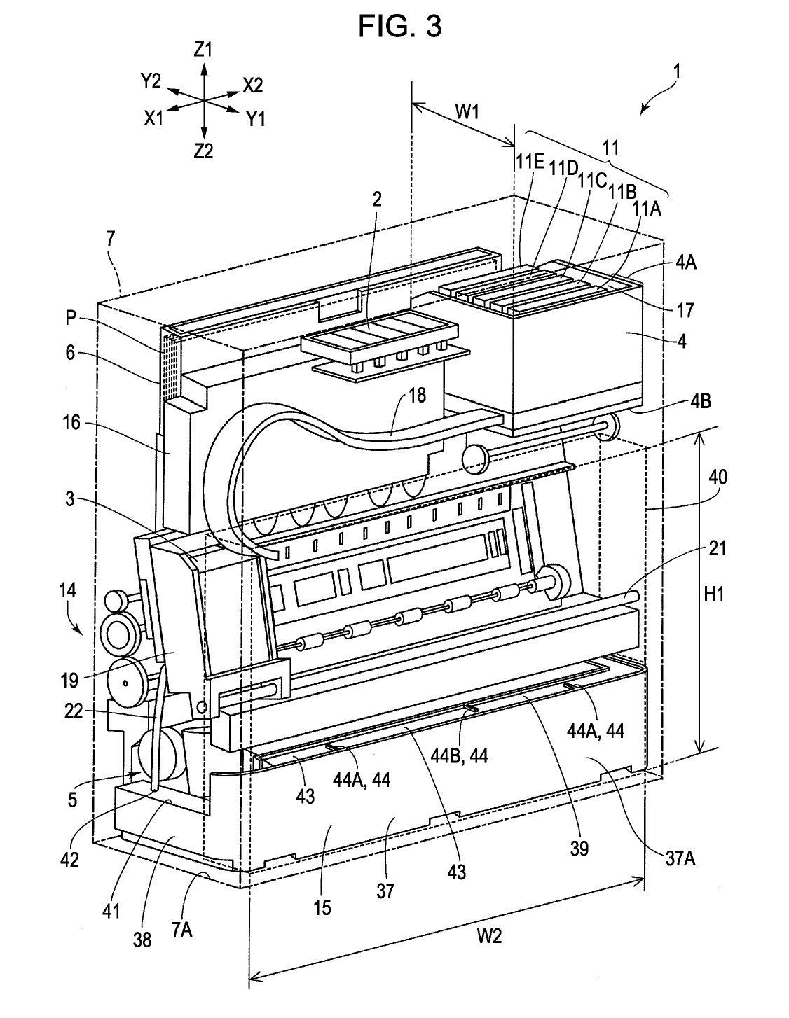

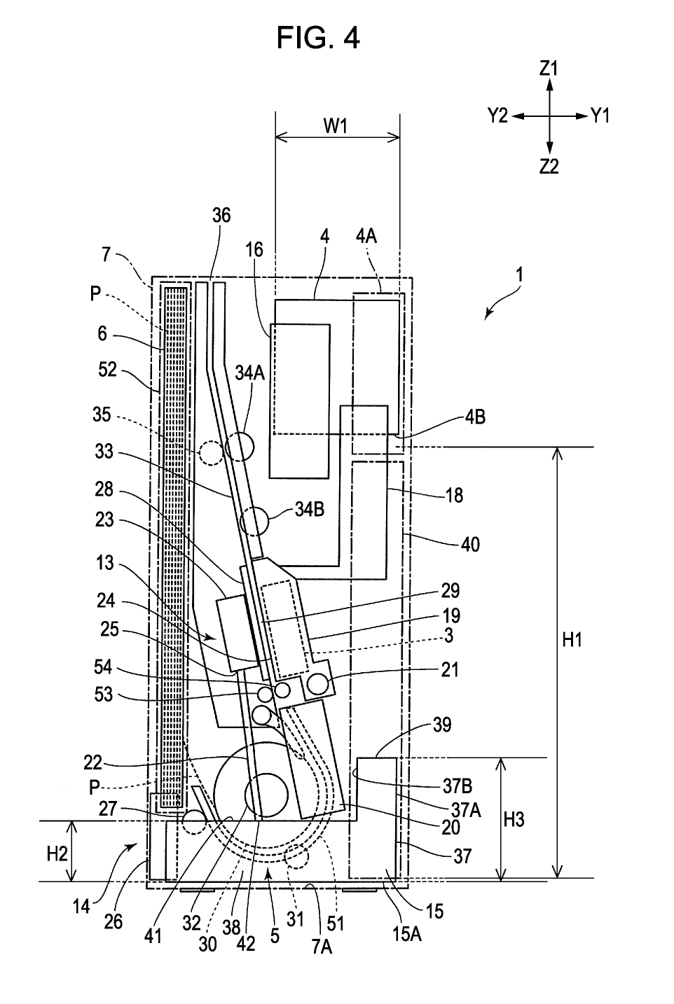

The printer 1 is configured as a vertical installation type printer in which a recording head 3 (refer to FIGS. 3 and 4) as a liquid ejecting head, an ink tank loading section 4 (refer to FIGS. 3 and 4) as a liquid container loading section, and a transport mechanism 5 (refer to FIG. 4), which are disposed in the inside of the printer 1, are disposed in the up-and-down direction Z1-Z2 as a second direction as a whole. In the printer 1, the transport mechanism 5, the recording head 3, and the ink tank loading section 4 are disposed in order from the lower side. In addition, the printer 1 can record characters, graphics, or the like on recording paper P as a target by ejecting ink as liquid from the recording head 3 onto the recording paper P.

In the printer 1, a paper cassette 6 with the recording papers P accommodated therein is loaded at a given position of the printer 1, whereby a state is created where the recording paper P is loaded into the printer 1. FIG. 1 shows a state where the loading of the paper cassette 6 with the recording papers P accommodated therein into the printer 1 has been completed. FIG. 2 shows a state where the paper cassette 6 is being loaded into the printer 1 or the paper cassette 6 is being extracted from the printer 1.

The printer 1 presents a rectangular parallelepiped which is flat (a dimension in the front-and-back direction is smaller than those in other directions) in the front-and-back direction as a whole and long in the up-and-down direction compared to the left-and-right direction, as shown in FIGS. 1 and 2. For example, in a case where the printer 1 is installed indoors, usually, the printer 1 is installed such that a back surface 1B of an outer casing 7 faces a wall surface and the front surface 1A side faces a room inside. For this reason, in the printer 1, the front surface 1A, a top surface 1C, a left surface 1D, and a right surface 1E of the outer casing 7 become portions easily visible from the viewpoint of an operator. That is, a design of the outer casing 7 of the printer 1 is made to be a design in which an idea is applied to the front surface 1A, the top surface 1C, the left surface 1D, and the right surface 1E.

On the top surface 1C of the printer 1, a power switch 8, the operation buttons 2, a paper cassette insertion opening 9, an ink tank mounting and removal opening 10, and the like are provided. The paper cassette insertion opening 9 is an opening for performing insertion and removal of the paper cassette 6 into and from the printer 1. The ink tank mounting and removal opening 10 is an opening for performing taking-in and taking-out of an ink tank 11 (refer to FIG. 3) when performing mounting and removal of the ink tank 11 with respect to the ink tank loading section 4 (refer to FIGS. 3 and 4). The ink tank mounting and removal opening 10 is made to be capable of being opened and closed by a cover 12, and the mounting and removal of the ink tank 11 on and from the ink tank loading section 4 can be performed in a state where the cover 12 has been opened. An array of an operating section, a direction such as an operation direction, or the like is set such that when an operator operates the printer 1 from the front of the printer 1, the power switch 8, the operation buttons 2, the paper cassette insertion opening 9, the cover 12, and the like are easily operated.

Next, the internal configuration of the printer 1 will be described with reference to FIGS. 3 and 4. FIGS. 3 and 4 schematically show the internal configuration of the printer 1. FIG. 3 shows the internal configuration of the printer 1 when viewing the printer 1 from a direction above and obliquely to the left. Further, FIG. 4 shows the internal configuration of the printer 1 when viewing the printer 1 from the left side. In FIGS. 3 and 4, in order to clarify the structure of the printer 1, the illustrations or the shapes of members are appropriately omitted or simplified.

The printer 1 includes the ink tank loading section 4, the recording head 3, a suction mechanism 13, a recording paper supply mechanism 14 as a target supply mechanism, a recording paper accommodating section 52 as a target accommodating section, the transport mechanism 5, a waste ink container 15 as a waste liquid container, a control box 16 in which a control substrate or the like which assumes the control of the printer 1 is accommodated, and the like. The ink tank loading section 4, the recording head 3, and the transport mechanism 5 are arranged in the up-and-down direction Z1-Z2 as a whole, as described above, and the recording paper accommodating section 52, the transport mechanism 5, and the waste ink container 15 are arranged in the horizontal direction Y1-Y2 as a first direction as a whole.

### Ink Tank Loading Section 4

The ink tank 11 in which ink is stored is detachably loaded into the ink tank loading section 4. In this embodiment, the ink tank 11 is constituted as five ink tanks 11A, 11B, 11C, 11D, and 11E, in which ink of different colors are stored. As the colors of ink, for example, ink of black, magenta, cyan, photo-cyan, and yellow are present. The ink tank loading section 4 and the ink tanks 11A to 11E have configurations in which the ink tanks 11A to 11E can be individually mounted or removed with respect to the ink tank loading section 4. That is, each of the ink tanks 11A to 11E is configured as a so-called cartridge type ink tank. The ink tanks 11A to 11E are arranged in the front-and-back direction and the ink tank loading section 4 has a width W1 in the front-and-back direction. In addition, in the following explanation, there is also a case where the ink tanks 11A to 11E are collectively described as the ink tank 11 or an individual ink tank is simply described as the ink tank 11.

The ink tank loading section 4 presents a box body having an opening portion 17 at the upper side and the ink tank 11 can be mounted and removed through the opening portion 17 and the ink tank mounting and removal opening 10 which is formed in the top surface 1C (refer to FIGS. 1 and 2). The ink tank loading section 4 is disposed immediately below the top surface 1C such that it is disposed at the highest position among the recording head 3, the suction mechanism 13, the recording paper supply mechanism 14, the recording paper accommodating section 52, the transport mechanism 5, the waste ink container 15, and the control box 16 and the mounting and removal of the ink tank 11 can be performed from the ink tank mounting and removal opening 10 which is provided in the top surface 1C. The printer 1 is often generally installed on a floor surface or a desk. For this reason, in a case where a configuration has been made in which the mounting and removal of the ink tank 11 is performed at the front surface 1A, the left surface 1D, or the right surface 1E, an operator who performs the mounting and removal operations of the ink tank 11 is sometimes forced to take such a posture to look at the front surface 1A, the left surface 1D, or the right surface 1E. Further, in a case where a configuration has been made in which the mounting and removal of the ink tank 11 is performed at the back surface 1B or the bottom 1F side, movement of the printer 1 is sometimes required. On the contrary, by making a configuration in which the mounting and removal of the ink tank 11 can be performed at the top surface 1C side, an operator can easily perform the mounting and removal operations of the ink tank 11 in a natural posture from obliquely above in front of the printer 1.

### Recording Head 3

As the recording head 3, for example, a head of a piezo type ink jet form or a thermal jet type ink jet form can be used, and the recording head 3 can eject ink which is supplied from the ink tank 11 which is connected thereto through an ink supply tube 18. The recording head 3 is mounted on a carriage 19. Further, the printer 1 has a configuration in which the carriage 19 with the recording head 3 mounted thereon can reciprocate along a guide member 21 by the driving force of a driving motor 20. The driving motor 20 and the carriage 19 are connected to each other through a drive transmission mechanism (not shown). The driving force of the driving motor 20 is transmitted to the carriage 19 through the drive transmission mechanism, whereby the carriage 19 is reciprocated.

The guide member 21 has a guide direction set in a main scanning direction (the left-and-right direction in the drawing) which is a direction perpendicular to a sub-scanning direction which is the transport direction of the recording paper P by the transport mechanism 5 which will be described later. That is, the carriage 19 can reciprocate in the main scanning direction along the guide member 21 by the drive transmission mechanism (not shown). The printer 1 can perform given recording on the recording paper P by ejecting ink onto the recording paper P while transporting the recording paper P in the sub-scanning direction by the transport mechanism 5 and also moving the recording head 3 in the main scanning direction.

The printer 1 has a configuration in which the recording head 3 is reciprocated in the main scanning direction with respect to the printer 1, whereas the ink tank 11 is made to be at a fixed position which does not move with respect to the printer 1. That is, the printer 1 is configured as a so-called off-carriage type printer in which the ink tank 11 and the recording head 3 are disposed at different places. As for the printer, in addition to the off-carriage type, a so-called on-carriage type printer having a configuration in which an ink tank is mounted along with a recording head on a carriage is present. In the off-carriage type printer, since the ink tank is not mounted on the carriage, it is possible to make an inertial force at the time of movement of the carriage small, compared to the on-carriage type printer. For this reason, the printer 1 can make a driving force for driving the carriage 19 small compared to the case of configuring the printer as the on-carriage type, so that it is possible to attain lower power consumption or simplification of the drive transmission mechanism.

Further, the printer 1 can attain a reduction in vibration which is generated due to the movement of the carriage 19, compared to the case of configuring the printer as the on-carriage type. The printer 1 is a vertical installation type, so that the position of the center of gravity tends to become high compared to a transverse installation type printer and stability at the time of installation tends to become impaired. However, by making the printer 1 the off-carriage type, a reduction in vibration which is generated due to the movement of the carriage 19 is attained, so that stability at the time of installation of the printer 1 can be improved.

In the printer 1, the supply of ink from the ink tank 11 to the recording head 3 is performed using a head difference and the ink tank 11 is disposed above the recording head 3. Further, in the printer 1, the ink tank 11 is disposed immediately below the top surface 1C such that the mounting and removal of the ink tank 11 can be performed from the ink tank mounting and removal opening 10 which is provided in the top surface 1C. For this reason, the position of the center of gravity of the printer 1 tends to become higher. However, by configuring the printer 1 to be the off-carriage type, it is possible to make an inertial force at the time of the movement of the carriage 19 small, so that stability at the time of installation of the printer 1 can be improved. In particular, in the printer 1 in which the ink tank 11 is disposed immediately below the top surface 1C, if the number of colors of the ink tank 11 or the number of ink tanks 11 is increased or the capacity of the tank is increased, the position of the center of gravity of the printer 1 tends to become higher. However, by configuring the printer 1 to be the off-carriage type, it is possible to improve stability at the time of installation of the printer 1.

### Suction Mechanism 13

At the left end position of the moving range in the main scanning direction of the carriage 19, the suction mechanism 13 is disposed. The suction mechanism 13 has a configuration capable of carrying out a so-called cleaning operation of suctioning ink in the recording head 3, thereby forcibly discharging air bubbles which are mixed in an ink flow path in the recording head 3 and the ink supply tube 18. Further, the suction mechanism 13 has a configuration capable of receiving ink ejected by so-called flushing in which ink is ejected independently of recording, for the purpose of prevention of thickening of ink in the recording head 3, or the like. Waste ink suctioned to the suction mechanism 13 or waste ink ejected by the flushing is discharged into the waste ink container 15 through a waste ink tube 22.

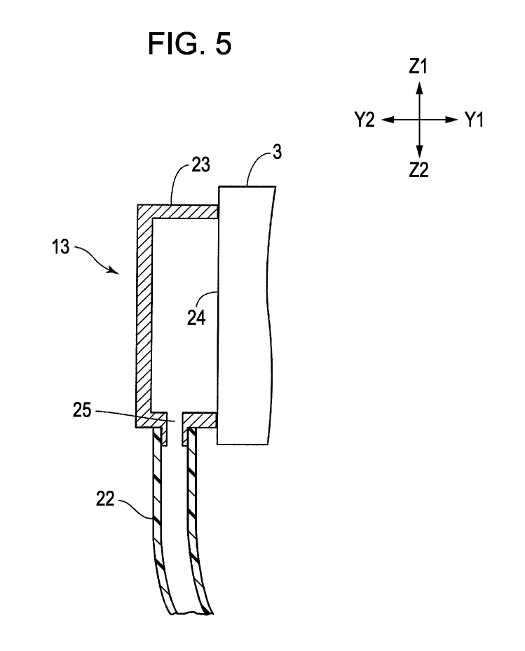

FIG. 5 is a diagram showing a schematic configuration in a state where a cap section 23 as a waste liquid receiving section constituting a portion of the suction mechanism 13 is connected to the recording head 3, viewed from the left side. In FIG. 5, the cap section 23 and the waste ink tube 22 which is connected to the cap section 23 are shown as a cross-sectional view. A pump (not shown) is connected to the waste ink tube 22 and the suction mechanism 13 is configured such that negative pressure can be generated in the inside of the cap member 23 by the pump.

The suction mechanism 13 carries out a cleaning operation or a flushing operation by generating negative pressure in the cap section 23 in a state where a nozzle formation face 24, in which nozzle portions of the recording head 3 in which ejection of ink is performed are formed, has been covered by the cap section 23, as shown in FIG. 5. The waste ink discharged from the recording head 3 is discharged from a waste ink discharging portion 25 as a waste liquid discharging portion, to which the waste ink tube 22 is connected, into the waste ink container 15 through the waste ink tube 22.

### Recording Paper Accommodating Section 52

The recording paper accommodating section 52 is a section into which the paper cassette 6 of the printer 1 is loaded. The recording paper accommodating section 52 includes a guide member which guides the paper cassette 6 to a given setting position, a positioning member which positions the paper cassette 6 set at the given setting position, or the like.

### Recording Paper Supply Mechanism 14

As shown in FIG. 2, by inserting the paper cassette 6 with the recording papers P loaded therein from the paper cassette insertion opening 9 into the printer 1 and pushing the paper cassette 6 down up to a given position, the loading of the paper cassette 6 into the printer 1 is completed, as shown in FIGS. 1, 3, and 4. In a state where the paper cassette 6 has been loaded at the given position of the printer 1, the recording papers P are drawn out one by one from the inside of the paper cassette 6 by the recording paper supply mechanism 14, thereby being supplied toward the transport mechanism 5.

The recording paper supply mechanism 14 is disposed as a whole below the paper cassette 6 loaded at the given position and at a peripheral portion of a lower end portion of the paper cassette 6. The recording paper supply mechanism 14 has a function to draw out the recording paper P from the paper cassette 6, thereby transporting it to the transport mechanism 5, and is constituted, for example, by a hopper mechanism 26, a retard roller 27, and the like. That is, the recording paper supply mechanism 14 displaces the lower portion side of the recording paper P in the paper cassette 6 to the front (the retard roller 27 side) by the hopper mechanism 26, thereby bringing the recording paper P into contact with the retard roller 27. Then, one sheet which is located most at the retard roller 27 side among the recording papers P which are stacked is transported toward the transport mechanism 5 by the rotation of the retard roller 27.

In this embodiment, the recording paper supply mechanism 14 is constituted by the hopper mechanism 26, the retard roller 27, and the like. However, it is not limited such a mechanism and it is also possible to adopt, for example, a mechanism of extracting one by one the recording papers P by a pin, or a mechanism of suctioning and extracting the recording paper P. Further, the printer 1 may also have a configuration in which a paper stocker is provided at the recording paper accommodating section 52, whereby the recording papers P are directly loaded into the paper stocker without using the paper cassette 6, in addition to the configuration in which the paper cassette 6 is loaded into the recording paper accommodating section 52.

### Transport Mechanism 5

The transport mechanism 5 has a function to transport the recording paper P supplied from the recording paper supply mechanism 14 toward a recording area 29 which is formed between a paper support member 28 and the recording head 3 and is constituted by a transport roller 30, a presser roller 31, a guide member 51, and the like. The transport roller 30 is driven by a driving motor 32. Further, the guide member 51 presents a U-shape having a bent portion at the lower side such that the travelling direction of the recording paper P which is sent downward from the paper cassette 6 side is turned to the upper side which becomes the recording head 3 side.

The recording paper P supplied from the paper cassette 6 to the transport mechanism 5 by the recording paper supply mechanism 14 is guided to between the transport roller 30 and the presser roller 31 by the guide member 51. Then, the recording paper P guided to between the transport roller 30 and the presser roller 31 is transported toward the recording area 29 along the guide member 51 by the rotation of the transport roller 30. The recording area 29 is at a position where the recording paper P can receive ejection of ink from the recording head 3, and in the recording area 29, recording by ink is performed on the recording paper P. The recording paper P transported to the recording area 29 is sent along a guide member 33 which is provided to extend upward from the paper support member 28, and then discharged to the outside of the printer 1 at a discharge opening 36 by a feeding roller 53, a driven roller 54 which is driven and rotated by the feeding roller 53, paper discharge knurled rollers 34A and 34B, and a paper discharge roller 35.

The recording paper P is loaded into the paper cassette 6 in a state where the surface of paper (a recording surface) follows the up-and-down direction. Further, the guide member 33 is provided to extend upward in a steep gradient from the paper support member 28, as shown in FIG. 4. The guide member 51 presents a U-shape having a bent portion at the lower side. Therefore, a configuration is made in which the recording paper P which is loaded into the paper cassette 6 in a state where the surface of paper (a recording surface) follows the up-and-down direction is transported downward by the recording paper supply mechanism 14, the transport direction of the recording paper P is then changed to the upper side by the guide member 51, and the recording paper P is discharged from the discharge opening 36 along the guide member 33. That is, in the printer 1, a transport pathway which is a pathway where the recording paper P is transported presents an approximate U-shape in which the recording paper P which is transported downward from above is reversed in transport direction at the lower side and transported upward. Further, the transport mechanism 5, the recording head 3, and the ink tank loading section 4 are arranged in the up-and-down direction Z1-Z2 as a whole. In this manner, by making the transport pathway of the recording paper P an approximate U-shape in which a bent portion is located at the lower side and also making the array direction of the transport mechanism 5, the recording head 3, and the ink tank loading section 4 the up-and-down direction, it is possible to make the thickness in the front-and-back direction of the printer 1 thin.

### Waste Ink Container 15

The waste ink container 15 has a main container portion 37 (a first container portion) and an extension portion 38 (a second container portion). At an upper portion of the main container portion 37, an opening portion 39 is formed. The main container portion 37 becomes a principal portion in which capacity is large compared to the extension portion 38 and the waste ink is stored. In the waste ink container 15, the main container portion 37 is disposed at the side opposite to the recording paper supply mechanism 14 across the transport mechanism 5. That is, the main container portion 37, the transport mechanism 5, and the recording paper supply mechanism 14 are arranged in order of the transport mechanism 5 and the main container portion 37 ahead of the recording paper supply mechanism 14. The array direction of the transport mechanism 5, the recording head 3, and the ink tank loading section 4 is the up-and-down direction Z1-Z2 as a whole, whereas the array direction of the recording paper supply mechanism 14, the transport mechanism 5, and the main container portion 37 is made to be the horizontal direction Y1-Y2 as a whole.

The main container portion 37 occupies a great portion of the capacity of the waste ink container 15. Therefore, the extension portion 38 is not disposed ahead of the transport mechanism 5, but disposed beside (at the left side of) the transport mechanism 5. However, the waste ink container 15 including the extension portion 38 is disposed in front of the transport mechanism 5 as a whole. That is, the recording paper supply mechanism 14, the transport mechanism 5, and the waste ink container 15 are arranged in order of the recording paper supply mechanism 14, the transport mechanism 5, and the waste ink container 15 from the rear toward the front.

As shown in FIGS. 3 and 4, the recording head 3 and the transport mechanism 5 are disposed below the ink tank loading section 4. Further, the ink tank loading section 4 on which a plurality of ink tanks 11A to 11E are loaded has the width W1 in the front-and-back direction and a portion of the ink tank loading section 4 becomes a projecting portion 4A which projects so as to stick out above the recording head 3 and the transport mechanism 5 toward the front. Therefore, a space 40 is formed below the projecting portion 4A at a position which becomes the front of the recording head 3 and the transport mechanism 5. Then, in the space 40, the main container portion 37 which is a portion of the waste ink container 15 is disposed. That is, the space 40 is present as a so-called dead space within the printer 1, and by disposing the waste ink container 15 in the space 40, it is possible to dispose the waste ink container 15 while suppressing an increase in the volume of the printer 1, that is, the larger in the shape of the exterior.

A width W2 in the left-and-right direction of the space 40 can be secured in a width close to the width in the left-and-right direction of the internal space of the outer casing 7 and a height H1 in the up-and-down direction of the space 40 can be secured in an internal dimension interval between a bottom plate portion 7A of the outer casing 7 and a lower surface 4B of the ink tank loading section 4. Therefore, by enlarging the main container portion 37 in the left-and-right direction or the up-and-down direction, it is possible to effectively increase the volume of the main container portion 37 while suppressing an increase in the volume of the printer 1. The waste ink container 15 is installed on the bottom plate portion 7A of the outer casing 7 which is at the lowest position in the printer 1. Therefore, it is possible to dispose the waste ink container 15 in the printer 1 while suppressing a rise in the position of the center of gravity of the printer 1.

The extension portion 38 is provided at a left end portion of the main container portion 37 and disposed in a space which is formed between a lower portion of the driving motor 32 and the bottom plate portion 7A. The space is also a so-called dead space. In this manner, by providing the waste ink container 15 in the space, it is possible to effectively increase the volume of the waste ink container 15 while suppressing an increase in the volume of the printer 1.

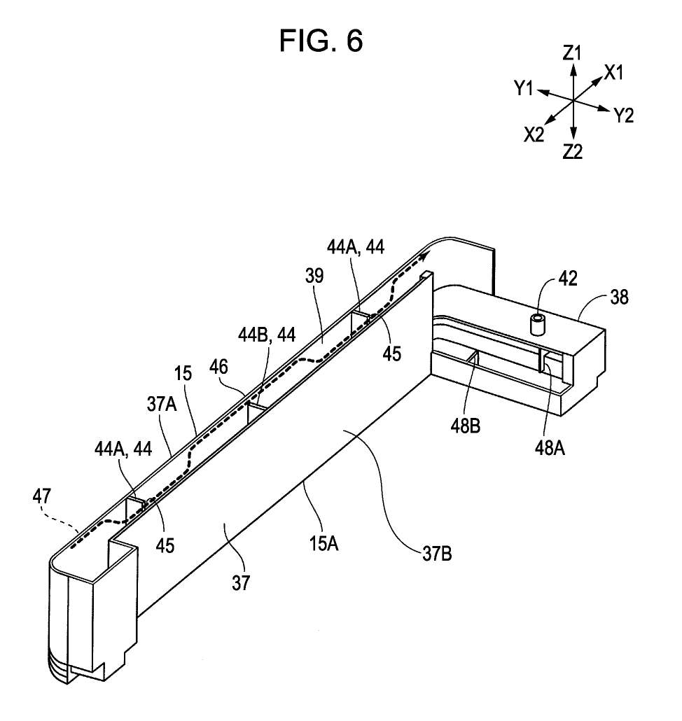

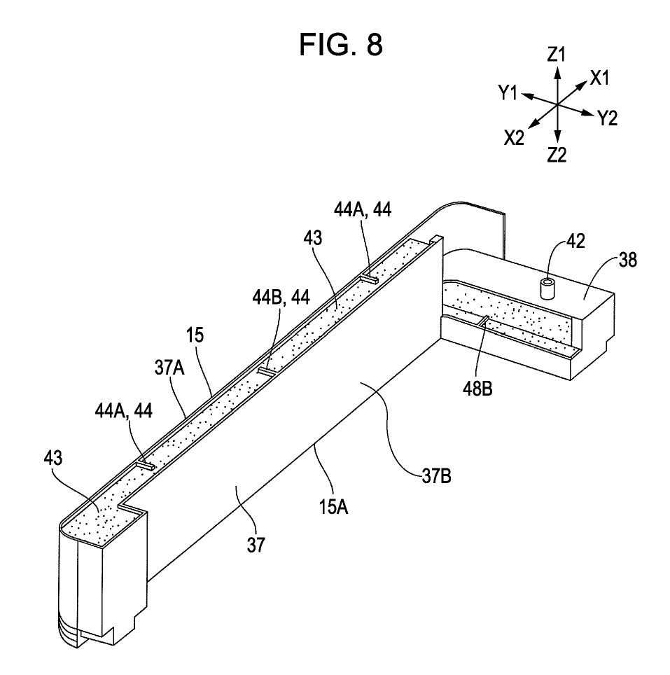

In the printer 1, the waste ink tube 22 is connected to a tube connection portion 42 (refer to FIGS. 6 and 8) as an inflow opening which is formed in a top plate 41 of the extension portion 38. The waste ink suctioned by the suction mechanism 13 is discharged into the waste ink container 15 from the tube connection portion 42 to which the waste ink tube 22 is connected.

In the inside of the waste ink container 15, an ink absorber 43 which is formed by, for example, felt, pulp, non-fiber paper, or the like is accommodated. In the printer 1, the ink absorber 43 is accommodated over the almost entirety of the inside of the waste ink container 15. That is, the ink absorber 43 is accommodated in the waste ink container 15 in a filled state. The ink absorber 43 is formed by a myriad of intertwined fibers and has a function to draw ink by capillary action. Therefore, the waste ink which has flowed from the tube connection portion 42 into the extension portion 38 is absorbed into the ink absorber 43 and permeates into the entirety of the ink absorber 43.

A height H2 of the extension portion 38 is lower than a height H3 of the main container portion 37. Therefore, in a case where the ink absorber 43 is not accommodated in the waste ink container 15, the waste ink container 15 cannot store ink to the height H2 or more of the extension portion 38. However, the ink absorber 43 is accommodated in the waste ink container 15, whereby in the main container portion 37, it is possible to accommodate the waste ink beyond the height H2.

Since the ink absorber 43 has a function to retain ink by capillary action, the ink absorber 43 can retain ink in a state where ink is sucked up to a position higher than the tube connection portion 42. That is, the ink absorber 43 is accommodated in the waste ink container 15, whereby it is possible to increase the degree of freedom of disposition of the inflow opening (the tube connection portion 42) which allows the waste ink from the suction mechanism 13 to flow into the waste ink container 15. For example, it is possible to dispose the inflow opening at a position lower than the waste ink discharging portion 25. For this reason, compared to a case where the inflow opening is disposed at a position higher than the waste ink discharging portion 25, it is possible to suppress a reduction in the size of a pump (not shown) of the suction mechanism 13 or consumption of electric power for driving the pump.

In addition, the opening portion 39 is formed in the waste ink container 15, whereby the moisture of the waste ink absorbed into the ink absorber 43 easily evaporates. Due to evaporation of the moisture, the allowable absorbed amount of the ink absorber 43 is restored.

### Control Box 16

In the control box 16, a control substrate (not shown) or the like as a control section which can be provided with a CPU (Central Processing Unit), various memories in which a processing program, data, or the like related to various operations of the printer 1 is stored, or the like is accommodated, and the control section assumes control of an operation of the printer 1, such as drive control of the driving motors 20 and 32, the recording head 3, the pump of the suction mechanism 13, and the like.

### MAIN EFFECT OF THE EMBODIMENT

As described above, the printer 1 as a liquid ejecting apparatus includes the recording head 3 as a liquid ejecting head, the suction mechanism 13 as a suction mechanism which suctions ink from the recording head 3, the recording paper accommodating section 52 as a target accommodating section which accommodates the recording paper P as a target which becomes an ejection target of ink which is ejected from the recording head 3, the transport mechanism 5 which transports the recording paper P which is supplied from the recording paper accommodating section 52, to the recording area 29 which is at a position where ejection of liquid from the recording head 3 can be received, and the waste ink container 15 as a waste liquid container which stores the waste ink discharged from the suction mechanism 13, and the recording paper accommodating section 52, the transport mechanism 5, and the waste ink container 15 are arranged in order of the transport mechanism 5 and the waste ink container 15 from a side of the recording paper accommodating section 52.

In a case where the printer 1 has a configuration as described above, the following can be said. That is, in this embodiment, the transport mechanism 5 is disposed so as to be interposed between the recording paper accommodating section 52 and the waste ink container 15, rather than a configuration in which the waste ink container 15 is disposed so as to spread all over the entirety of the bottom plate portion 7A of the outer casing 7. If the waste ink container 15 is made to be disposed at the bottom plate portion 7A of the outer casing 7 (below the transport mechanism 5), in order to secure the absorption capacity of the waste ink container 15, it is necessary not only to dispose the waste ink container 15 to spread all over the entirety of the bottom plate portion 7A, but also to increase the thickness in the up-and-down direction. Then, since the printer 1 becomes high, stability becomes impaired. However, by disposing the transport mechanism 5 so as to be interposed between the recording paper accommodating section 52 and the waste ink container 15, in other words, by making the transport mechanism 5 be disposed between the recording paper accommodating section 52 and the waste ink container 15, it is possible not only to effectively utilize the dead space, but also to reduce the height of the printer 1, so that stability can be enhanced. At this time, the recording paper accommodating section 52, the transport mechanism 5, and the waste ink container 15 are arranged in the horizontal direction Y1-Y2 as the first direction as a whole. In addition, the above points are effects in a case where the printer 1 is vertically installed and used, and, for example, in a case where the printer 1 is laterally installed and used (a case where the Y1-Y2 direction becomes the up-and-down direction), a so-called depth of the printer 1, which is the Z1-Z2 direction, can be reduced, so that it becomes possible to reduce the installation area of the printer 1. Then, the printer 1 may not be a combined use type printer in which both vertical installation and transverse installation are possible, or may also be a vertical installation dedicated printer.

Further, the printer 1 includes the recording head 3, the ink tank loading section 4 as a liquid container loading section which is disposed at a position different from the recording head 3 and into which the ink tank 11 as a liquid container is loaded, the recording paper accommodating section 52, the transport mechanism 5, and the waste ink container 15. Then, the recording paper accommodating section 52, the transport mechanism 5, and the waste ink container 15 are arranged in order of the transport mechanism 5 and the waste ink container 15 from a side of the recording paper accommodating section 52, and the transport mechanism 5, the recording head 3, and the ink tank loading section 4 are arranged in order of the recording head 3 and the ink tank loading section 4 from a side of the transport mechanism 5. Further, the horizontal direction as the first direction which is the array direction of the recording paper accommodating section 52, the transport mechanism 5, and the waste ink container 15 and the up-and-downs direction as the second direction which is the array direction of the transport mechanism 5, the recording head 3, and the ink tank loading section 4 are perpendicular to each other. Then, the ink tank loading section 4 has the projecting portion 4A which projects in a direction which is the horizontal direction and is further forward than the recording head 3 and the transport mechanism 5, that is, a direction toward a side opposite to a side where the recording paper accommodating section 52 is disposed. The waste ink container 15 is disposed in the space 40 which is formed on a side of the transport mechanism 5 along the lower side from the projecting portion 4A. The waste ink container 15 is disposed in the space 40 which is formed below the projecting portion 4A, that is, on the transport mechanism 5 side of the projecting portion 4A in a direction following the second direction.

Since the printer 1 has the above-described configuration, it is possible to dispose the waste ink container 15 in the space 40 as a dead space which is formed below the projecting portion 4A of the ink tank loading section 4. By disposing the waste ink container 15 in the space 40 in this manner, it is possible to provide the waste ink container 15 while suppressing an increase in the volume of the printer 1.

In addition, it is acceptable if the up-and-down direction which is the array direction of the transport mechanism 5, the recording head 3, and the ink tank loading section 4 is arranged in the up-and-down direction as a whole. For example, in a case where the transport mechanism 5 and the ink tank loading section 4 are arranged having portions overlapping in the up-and-down direction with respect to the recording head 3, it is possible to make the array of the transport mechanism 5, the recording head 3, and the ink tank loading section 4 an array in the up-and-down direction. That is, if the transport mechanism 5 and the ink tank loading section 4 are arranged having portions overlapping in the up-and-down direction with respect to the recording head 3, it is possible to configure the printer 1 as a vertical installation type printer in which an installation area is sufficiently small compared to a transverse installation type printer.

Further, it is acceptable if the horizontal direction which is the array direction of the recording paper accommodating section 52, the transport mechanism 5, and the waste ink container 15 is also arranged in the horizontal direction as a whole. For example, in a case where the recording paper accommodating section 52 and the waste ink container 15 are arranged having portions overlapping in the horizontal direction with respect to the transport mechanism 5, it is possible to make the array of the recording paper accommodating section 52, the transport mechanism 5, and the waste ink container 15 an array in the horizontal direction. That is, if the recording paper accommodating section 52 and the waste ink container 15 are arranged having portions overlapping in the horizontal direction with respect to the transport mechanism 5, it is possible to keep the height of the printer 1 low compared to a case where the waste ink container 15 is disposed below the transport mechanism 5. Further, by keeping the height of the printer 1 low, the position of the center of gravity of the printer 1 is easily set at a height where stability at the time of installation of the printer 1 can be sufficiently secured in a normal use aspect in which vibration is not intentionally imparted.

In the explanation of this embodiment, a crossing state of the array direction (the first direction) of the recording paper accommodating section 52, the transport mechanism 5, and the waste ink container 15 and the array direction (the second direction) of the transport mechanism 5, the recording head 3, and the ink tank loading section 4 is described by expression of the effect of being perpendicular to each other. However, when configuring the printer 1 related to the invention, strict orthogonal crossing is not required. By configuring the printer 1 such that the first direction and the second direction cross each other, it is possible to form the space 40 in the printer 1. Then, by disposing the waste ink tank 15 in the space 40, it is possible to provide the waste ink tank 15 while suppressing an increase in the volume of the printer 1.

However, by making the crossing state of the first direction and the second direction an orthogonal state or an approximately orthogonal state, it is possible to make the installation area of the printer 1 smaller while forming the space 40. In addition, in the approximately orthogonal state, for example, in a case where the transport mechanism 5 and the ink tank loading section 4 are arranged within a range having portions overlapping in the up-and-down direction with respect to the recording head 3 and the recording paper accommodating section 52 and the waste ink container 15 are arranged within a range having portions overlapping in the horizontal direction with respect to the transport mechanism 5, the crossing state of the first direction and the second direction is set to cross within the range of the approximately orthogonal state.

In the printer 1, the transport mechanism 5 is disposed at the lowest side in the array of the recording head 3, the ink tank loading section 4, and the transport mechanism 5. By disposing the recording head 3, the ink tank loading section 4, and the transport mechanism 5 in this manner, three sections, the recording paper accommodating section 52, the transport mechanism 5, and the waste ink container 15 are disposed at the lower side of the printer 1, so that it is possible to dispose the center of gravity of the printer 1 which is a vertical installation type printer at a lower position.

In the waste ink container 15 which the printer 1 has, the ink absorber 43 as a liquid absorber is accommodated. The ink absorber 43 can retain the absorbed ink in the ink absorber 43. For this reason, the ink absorber 43 is accommodated in the waste ink container 15, whereby, even when the printer 1 has fallen, it is possible to prevent ink from leaking immediately from the waste ink container 15.

The waste ink which has flowed from the waste ink tube 22 into the ink absorber 43 which is disposed in the extension portion 38 is absorbed into the ink absorber 43 and permeates into the entirety of the ink absorber 43. For this reason, it is possible to increase the degree of freedom of the shape of the waste ink container 15 and it is possible to attain expansion in the capacity of the waste ink tank 15 by using the dead space in the printer 1.

Further, since the ink absorber 43 has a function to retain ink by capillary action, it is possible to retain ink in a state where ink is sucked up to a position higher than the tube connection portion 42. That is, the ink absorber 43 is accommodated in the waste ink container 15, whereby it is possible to increase the degree of freedom of disposition of the inflow opening which allows the waste ink from the suction mechanism 13 to flow into the waste ink container 15.

In the printer 1, the tube connection portion 42 which is the inflow opening in which the waste ink discharged from the recording head 3 by the suction mechanism 13 flows into the waste ink tank 15 is disposed below the waste ink discharging portion 25 which is formed at the cap section 23 as a waste liquid receiving section which receives the waste ink of the suction mechanism 13. For this reason, compared to a case where the tube connection portion 42 is disposed at a position higher than the waste ink discharging portion 25, it is possible to suppress a reduction in the size of the pump (not shown) of the suction mechanism 13 or consumption of electric power for driving the pump. Further, in the printer 1, the ink absorber 43 is accommodated in the waste ink container 15 such that a portion which is present further at the upper side than the height of the tube connection portion 42 is present. For this reason, it is possible to store the waste ink at a position higher than the tube connection portion 42, so that it is possible to attain an increase in the storage amount of the waste ink which can be stored in the waste ink container 15.

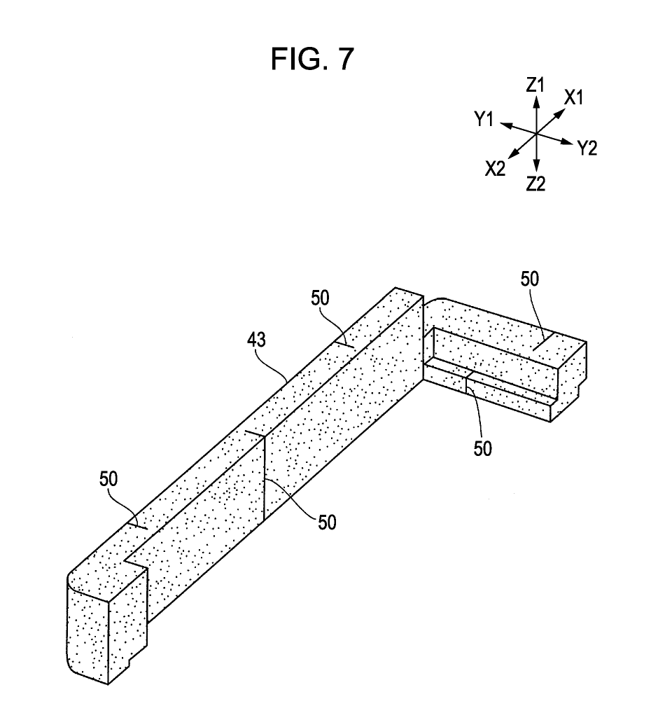

The above-described waste ink container 15 may also be made to have a configuration shown in FIG. 6. FIG. 6 is a diagram showing a state where the ink absorber 43 has been removed from the waste ink container 15, viewed from obliquely above. FIG. 7 is a perspective view showing the ink absorber 43 which is accommodated in the waste ink container 15. FIG. 8 is a diagram showing a state where the ink absorber 43 has been accommodated in the waste ink container 15.

As shown in FIG. 6, in the inside of the main container portion 37 of the waste ink container 15, a plurality of (in the illustration, three) barriers 44 which are arranged in the left-and-right direction are formed. The barriers 44 include a barrier 44A which is a wall portion protruding from a front plate portion 37A of the main container portion 37 toward the back plate portion 37B, and a barrier 44B which is a wall portion protruding from the back plate portion 37B toward the front plate portion 37A. The barriers 44A and 44B are connected to a bottom plate portion 15A of the waste ink container 15. The barrier 44A and the back plate portion 37B are not connected to each other and the gap between the barrier 44A and the back plate portion 37B is formed as a flow path 45. Further, the barrier 44B and the front plate portion 37A are not connected to each other and the gap between the barrier 44B and the front plate portion 37A is formed as a flow path 46. Then, the barriers 44A and 44B have the amounts of projection from the front plate portion 37A and the back plate portion 37B set such that the barriers 44A and 44B are alternately disposed and also have overlap portions in the left-and-right direction. Therefore, in the waste ink tank 15, a flow path 47 presenting a labyrinth pathway in the left-and-right direction of the main container portion 37 is formed by the barriers 44A and 44B.

The flow path 47 presents a labyrinth pathway, whereby it is possible to make it difficult for the waste ink in the waste ink container 15 to move in the left-and-right direction. For this reason, it is possible to make it difficult for the waste ink absorbed into the ink absorber 43 to flow back to the tube connection portion 42 side. Further, even at the time of falling of the printer 1, it is possible to make it difficult for the waste ink to spill from the waste ink container 15.

Further, also in the inside of the extension portion 38, barriers 48A and 48B which are wall portions are formed, so that the waste ink in the extension portion 38 is made to be difficult to move in the front-and-back direction. For this reason, at the time of falling or the like of the printer 1, it is possible to make it difficult for the waste ink to spill from the waste ink container 15.

As shown in FIG. 7, in the ink absorber 43, cuts 50 are formed at positions corresponding to the barriers 44 and the barriers 48A and 48B. When accommodating the ink absorber 43 in the waste ink container 15, the ink absorber 43 is accommodated by making the barriers 44 and the barriers 48A and 48B be inserted into the cuts 50. The barriers 44 and the barriers 48A and 48B are inserted into the ink absorber 43, whereby it is possible to prevent falling-out of the ink absorber 43 from the waste ink container 15 or biasing of the position where the ink absorber 43 is accommodated.

In the above-described embodiment, as one example of the liquid ejecting apparatus, the printer 1 has been illustrated as a vertical installation type printer. However, a transverse installation type printer is also acceptable. In this case, the first direction is disposed in a direction following the up-and-down direction and the second direction is disposed in a direction following the horizontal direction.

In addition, the concept of the printer 1 in the above-described embodiment can also be set to include fluid ejecting apparatuses which eject liquids (including liquid itself, liquid body in which particles of a functional material are dispersed or mixed in liquid, and a material having liquidity, such as gel) other than ink. As such apparatuses, there are a liquid body ejecting apparatus which ejects liquid which includes a material such as an electrode material or a color material (a pixel material) which is used for the manufacturing or the like of a liquid crystal display, an EL (electroluminescence) display, and a surface-emitting display, in a dispersed or dissolved form, a fluid ejecting apparatus which ejects biological organic matter which is used for the manufacturing of a biochip, a fluid ejecting apparatus which is used as a precision pipette and ejects liquid which becomes a sample, and the like.

Further, as apparatuses which are included in the concept of the liquid ejecting apparatus according to the invention, in addition to the printer 1, there are a fluid ejecting apparatus which ejects lubricant to a precision machine such as a clock or a camera by a pin point, a fluid ejecting apparatus which ejects transparent resin solution such as ultraviolet curing resin onto a substrate in order to form a hemispherical micro-lens (an optical lens) or the like which is used in an optical communication element or the like, a fluid ejecting apparatus which ejects an etching solution such as acid or alkali in order to etch a substrate or the like, a fluid body ejecting apparatus which ejects fluid body such as gel (for example, physical gel), and the like.

What is claimed is:

1. A liquid ejecting apparatus comprising:
a liquid ejecting head which ejects liquid;
a suction mechanism which suctions the liquid from the liquid ejecting head;
a target accommodating section which accommodates a target which becomes an ejection target of the liquid which is ejected from the liquid ejecting head;
a transport mechanism which transports the target which is supplied from the target accommodating section, to a position where ejection of the liquid from the liquid ejecting head can be received; and
a waste liquid container having a first container portion and a second container portion which store waste liquid discharged from the suction mechanism,
wherein the target accommodating section, the transport mechanism, and the first container portion are arranged in order of the transport mechanism and the first container portion from a side of the target accommodating section.

2. The liquid ejecting apparatus according to claim 1, further comprising:
a liquid container loading section which is disposed at a position different from the liquid ejecting head and into which a liquid container in which the liquid is stored is loaded,
wherein the transport mechanism, the liquid ejecting head, and the liquid container loading section are arranged in order of the liquid ejecting head and the liquid container loading section from a side of the transport mechanism,
a first direction which is the array direction of the target accommodating section, the transport mechanism, and the first container portion and a second direction which is the array direction of the transport mechanism, the liquid ejecting head, and the liquid container loading section cross each other, and
the liquid container loading section has a projecting portion which projects further than the liquid ejecting head and the transport mechanism in a direction which is a direction following the first direction and is a direction toward a side opposite to a side where the target accommodating section is disposed, and the first container portion is disposed in a space which is formed in a direction following the second direction and on the transport mechanism side of the projecting portion.

3. The liquid ejecting apparatus according to claim 2, wherein the first direction is a direction following the horizontal direction and the second direction is the up-and-down direction, and
the transport mechanism is disposed at the lowest side in the array of the transport mechanism, the liquid ejecting head, and the liquid container loading section.

4. The liquid ejecting apparatus according to claim 1, wherein the second container portion is provided to extend from the first container portion.

5. The liquid ejecting apparatus according to claim 1, wherein a liquid absorber is accommodated in the waste liquid container.

6. The liquid ejecting apparatus according to claim 5, wherein an inflow opening in which the waste liquid discharged from the liquid ejecting head by the suction mechanism flows into the waste liquid container is disposed below a waste liquid discharging portion which is formed at a waste liquid receiving section which receives the waste liquid of the suction mechanism, and
the liquid absorber is accommodated in the waste liquid container such that a portion which is present toward the upper side from the inflow opening is present.

7. The liquid ejecting apparatus according to claim 5, wherein barriers which form a labyrinth pathway capable of hindering the movement of liquid discharged into the waste liquid container are formed in the inside of the waste liquid container.
